(19) United States
(12) Patent Application Publication
(10) Pub. No.: US 2014/0319046 A1
(43) Pub. Date: Oct. 30, 2014

(54) CARBON NANOTUBE BASED NANOPOROUS MEMBRANES

(71) Applicant: INTERNATIONAL BUSINESS MACHINES CORPORATION, Armonk, NY (US)

(72) Inventor: Jose Miguel Lobez Comeras, New York, NY (US)

(73) Assignee: INTERNATIONAL BUSINESS MACHINES CORPORATION, Armonk, NY (US)

(21) Appl. No.: 13/870,653

(22) Filed: Apr. 25, 2013

(51) Int. Cl. B01D 71/70; B01D 67/00

(52) U.S. Cl. CPC B01D 71/70; B01D 67/0079; B01D 67/009
USPC 210/335; 210/500.21; 156/307.7; 156/250; 216/56

(57) ABSTRACT

A method for forming a nanopore membrane includes forming an array of carbon nanotubes on a substrate that are disposed side by side in a direction perpendicular to a length of the carbon nanotubes. The array of carbon nanotubes are embedded in a patternable polymer material. The patternable polymer material is crosslinked over the array of carbon nanotubes. An adhesive layer is deposited on the polymer material having the array of carbon nanotubes to form a pad. The pad is rolled using a transfer rod to form a membrane with carbon nanotubes of the array, forming nanopores through the membrane such that as the pad is rolled the membrane increases in diameter.

### BACKGROUND

1. Technical Field

The present invention relates to nanoporous membranes and more particularly to methods for fabrication and devices of carbon nanotube-based nanoporous membranes.

2. Description of the Related Art

Nanoporous graphitic materials such as, graphene, can be used for water desalination or contaminant removal from liquids, due to selective filtration of pure solvent molecules through the pores. Despite the great promise of these materials for several advanced applications such as purification, separation and sensing, nanopore fabrication in these examples relies either on serendipitous defect formation during the synthesis of the graphitic material, or the use of techniques that require costly batch processes, such as electron beam lithography. These shortcomings limit practical and large-scale production of membranes based on these materials.

### SUMMARY

A method for forming a nanopore membrane includes forming an array of carbon nanotubes on a substrate that are disposed side by side in a direction perpendicular to a length of the carbon nanotubes. The array of carbon nanotubes are embedded in a patternable polymer material. The patternable polymer material is crosslinked over the array of carbon nanotubes. An adhesive layer is deposited on the polymer material having the array of carbon nanotubes to form a pad. The pad is rolled using a transfer rod to form a membrane with carbon nanotubes of the array, forming nanopores through the membrane such that as the pad is rolled the membrane increases in diameter.

Another method for forming a nanopore membrane includes forming on a substrate a plurality carbon nanotube arrays such that the carbon nanotubes in each array are disposed side by side in a direction perpendicular to a length of the carbon nanotubes, the arrays being adjacent to one another in a direction of the length of the carbon nanotubes; embedding the arrays of carbon nanotubes in a patternable polymer material; crosslinking the patternable polymer material over the arrays of carbon nanotubes; depositing an adhesive layer on the polymer material; removing uncrosslinked polymer material between the arrays of carbon nanotubes to remove the adhesive layer thereon between the arrays such that pads are formed, the pads including polymer material with embedded carbon nanotubes and the adhesive layer; and rolling the pad using a transfer rod to form a membrane with carbon nanotubes of the arrays forming nanopores through the membrane such that as the pad is rolled the membrane increases in diameter.

A nanoporous membrane includes a portion of a transfer rod centrally disposed, and a polymer matrix including a plurality of embedded carbon nanotubes. The polymer matrix has a length wrapped around the portion of the transfer rod in a spiral path wherein portions of the polymer matrix are joined with adhesive along the spiral path.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a perspective view of a substrate having carbon nanotubes formed in arrays in accordance with the present principles;

FIG. 2 is a perspective view of the substrate of FIG. 1 showing the carbon nanotubes embedded in a polymer in accordance with the present principles;

FIG. 3 is a perspective view of the substrate of FIG. 2 showing the polymer crosslinked over the arrays of carbon nanotubes in accordance with the present principles;

FIG. 4 is a perspective view of the substrate of FIG. 3 showing an adhesive layer formed on the polymer in accordance with the present principles;

FIG. 5 is a perspective view of the substrate of FIG. 4 showing uncross-linked polymer removal in accordance with the present principles;

FIG. 6 is a perspective view of the substrate of FIG. 5 showing pads rolled up using a transfer rod in accordance with the present principles;

FIG. 7 is a perspective view showing pads rolled up to form a membrane using carbon nanotubes for pores in accordance with the present principles; and

FIG. 8 is a side view of the membrane using carbon nanotubes for pores in accordance with the present principles;

FIG. 9 is a perspective view of a membrane employed as a filter in accordance with the present principles;

FIG. 10 is a perspective view of a series filter with at least two membranes in accordance with the present principles; and

FIG. 11 is a block/flow diagram showing a method for forming a membrane with carbon nanotube pores in accordance with illustrative embodiments.

### DETAILED DESCRIPTION OF PREFERRED EMBODIMENTS

In accordance with the present principles, macroscopic carbon nanotube-based nanoporous membranes are provided in which parallel carbon nanotubes (CNT) are enclosed in a polymeric matrix. The CNTs include inner cavities that act as the pores of the membrane. To obtain a filtration membrane, aligned CNTs are embedded in a polymeric matrix that can then be rolled-up on itself, yielding a macroscopic filtration membrane.

By fabricating macroscopic filtration membranes in this way, large scale series production of nanoporous membranes is possible, and the membranes are easily tunable. A number of pores per membrane can be controlled and is defined by the number of nanotubes in the original array. Pore diameter and thus membrane selectivity can be tuned by use of carbon nanotubes of a certain diameter.

These membranes may be applied not only for filtration, but also for, e.g., nano-reaction channels for catalysis and confined chemical synthesis applications; separation and purification of organic and inorganic compounds with pharmacological applications; storage of chemicals and controlled release afterwards; sensors of analytes capable of going through the nanotube inner cavity triggering an electric response upon interaction of the analyte with the inner cavity of the nanotube.

To potentially manufacture membranes based on carbon nanotubes, the fabrication process needs to start with aligned carbon nanotubes, either parallel or perpendicular to a substrate. Controlled deposition of nanotubes parallel to a substrate can be performed; however, to make use of aligned arrays of carbon nanotubes as membranes is not obvious, since manipulation of the carbon nanotubes after deposition is non-trivial.

Nanotube alignment perpendicular to the substrate could be used for the fabrication of carbon-nanotube based membranes by making use of carbon nanotube forests. CNT forest growth would be followed by polymer infiltration, but CNT forest growth techniques are based on costly batch processes and only small area samples can be obtained, which limits the scope for realistic fabrication of membranes this way. Furthermore, polymer infiltration would lead to carbon nanotube misalignment, which would lead to pore blocking and would be detrimental for their application as membranes.

It is to be understood that the present invention will be described in terms of a given illustrative structure and method steps; however, other architectures, structures, substrate materials and process features and steps may be varied within the scope of the present invention.

It will also be understood that when an element such as a layer, region or substrate is referred to as being “on” or “over” another element, it can be directly on the other element or intervening elements may also be present. In contrast, when an element is referred to as being “directly on” or “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

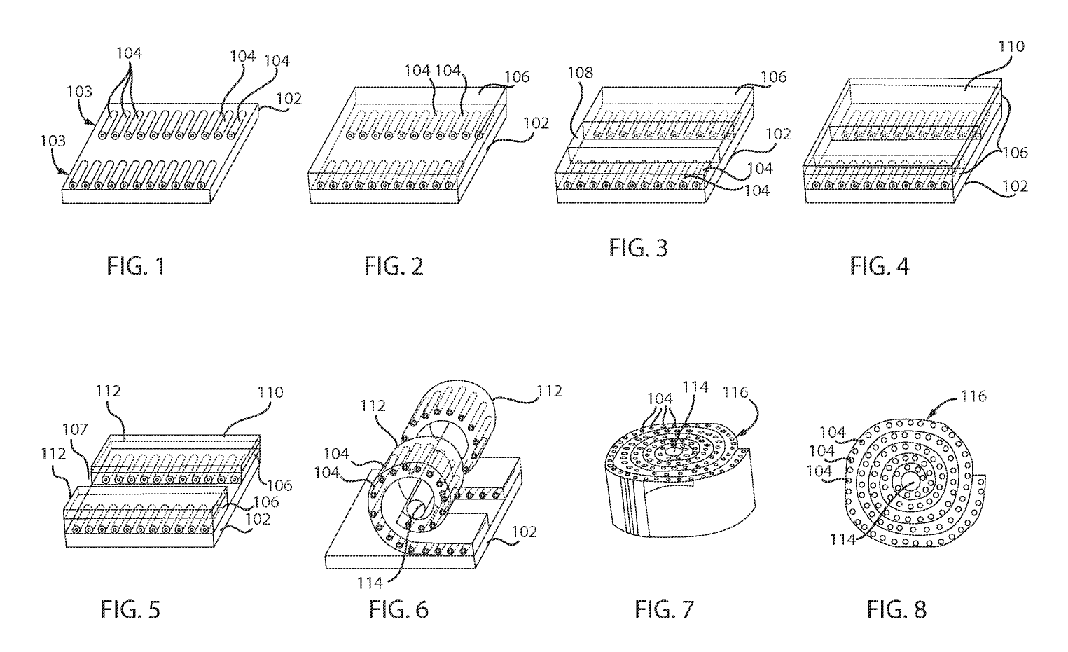

Referring now to the drawings in which like numerals represent the same or similar elements and initially to FIGS. 1-8, a fabrication process for forming a carbon nanotube-based nanoporous membrane is illustrative shown.

Referring to FIG. 1, parallel arrays 103 of aligned carbon nanotubes (CNT) 104 are formed on a substrate 102. The arrays 103 preferably include CNTs 104 laterally spaced apart from one another by a gap distance (the gap distance being perpendicular to a length of the CNTs 104). The gap distance that will be determined based upon a desired density of a final membrane. Several methods may be employed to obtain ordered arrays 103 of carbon nanotubes 104 over large areas on specific surfaces. These may include chemical vapor deposition (CVD) growth of nanotubes on substrates with a patterned catalyst, deposition using directed self-assembly, carbon nanotube film fabrication using Langmuir-Blodgett techniques, etc. The substrate 102 may include glass, plastic, metals, metal oxides or combinations thereof.

In FIG. 2, the CNTs 104 are embedded in a polymeric matrix 106 that can be cross-linked thermally or optically, such as polydimethylsiloxane (PDMS), which belongs to a group of polymeric organosilicon compounds (e.g., silicones). Other materials suitable for this purpose may include polymers or copolymers that can be deposited as a pre-polymer and crosslinked thereafter, such as, but not limited to, poly(butadiene), poly(styrene), etc.

A thickness and a length of the CNTs 104 may be adjusted. The thickness adjustment for the polymeric matrix 106 can be made to affect a density of pores and size in a final membrane. The length of the CNTs 104 may also be controlled to provide a width or thickness of the final membrane. This affects the filter path. The polymeric matrix 106 is then cross-linked in the areas where the carbon nanotube arrays 103 are present and remains uncrosslinked in other areas 108 in FIG. 3. A silicone capable of being photopolymerized can be used for this purpose. Exposure to ultra-violet (UV) radiation through a mask, will lead to cross-linking of the polymer only on the desired areas of the substrate 102. Other means by which area-selective cross-linking can be obtained include: thermal (exposure to heat), radiation induced (exposure to a beam of electrons, ions), etc.

Following polymer matrix deposition and patterning, an adhesive layer 110 is deposited on top of the polymeric matrix 106, which ultimately will hold the membrane together in FIG. 4. The adhesive layer 110 may include an epoxy resin, urea/formaldehyde resin, or any other kind of adhesive and may be deposited by a spinning process or a dip-coating process. The uncrosslinked portion of the polymer matrix 106 is then removed to form a gap 107 between parallel arrays 103 in FIG. 5. This may include the use of a developer or other material to remove the uncrosslinked portion.

In FIG. 6, the CNT/polymer composites or pads 112 can be rolled up by using a transfer rod 114, to which the composite can stick. The transfer rod 114 may include a rod of glass, metal, plastic or combination thereof, and the diameter can be tuned to affect the final dimensions of a membrane 116. The rod 114 can be operated manually or automatically to peel the pads 112 off the substrate. When the polymer matrix 106 is peeled-off, the carbon nanotubes 104 would also be peeled-off since they are embedded in the matrix 106. A concentric composite or membrane 116 of CNTs 104 in the polymer matrix 106 would be adhered to the transfer rod 114 as shown in FIG. 7.

In FIG. 8, the adhesive layer 110, being cured either thermally or optically, would yield a membrane where the only pores are the carbon nanotubes 104 parallel to the transfer rod 114 and embedded in the polymer matrix 106. A self-standing membrane 116 can be isolated by cutting the rod 114 using any cutting device, such as an automated surgical blade or a laser. An optional step of plasma or other etching may be employed to ensure openings for every nanotube are free of polymer residue (both sides).

A number of tubes 104 in each array 103 determines the number of pores in the final membrane 116. The thickness of the polymer matrix layer can be easily tuned depending on deposition conditions, which will ultimately affect membrane dimensions. The pore sizes can be determined by an inner diameter of the CNTs 104, which can range anywhere between fractions of a nanometer to several microns. The final dimensions of the membrane 116 will be determined by the diameter of the transfer rod 114, the thickness of the adhesive layer, and the number of times such layer is rolled up on itself, with final membrane dimensions between tens of nanometers to hundreds of microns to several centimeters. Membranes 116 can be used by themselves to filter-off undesired compounds, or in series.

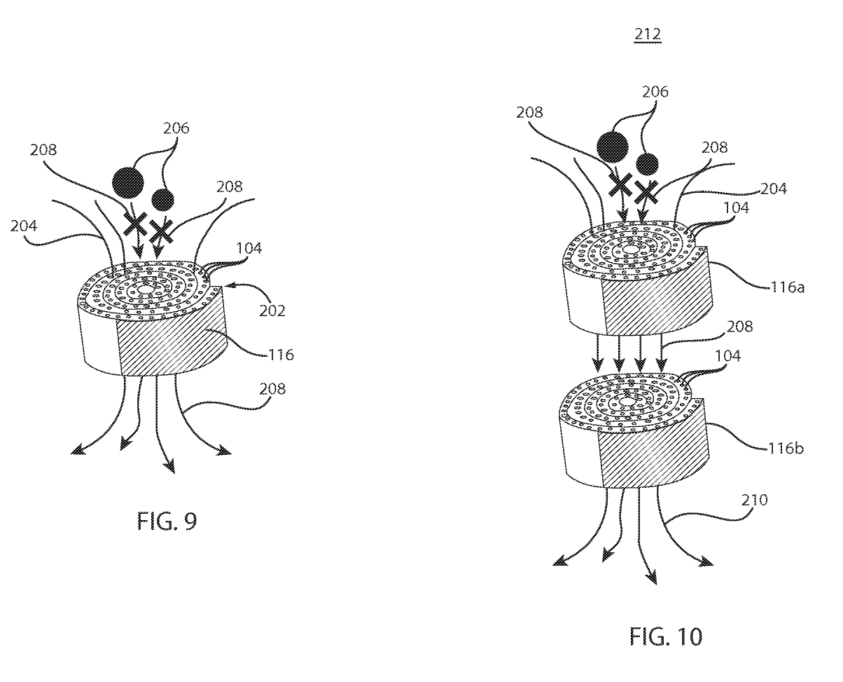

Referring to FIG. 9, a filter 202 includes a membrane 116 positioned to receive a fluid 204 with particles 206, contaminants 208, etc. therein. The particles 206, etc. are trapped by the membrane 116 if they are larger than the inner diameters of the CNTs 104. Smaller particles can pass through with filtered fluid 208.

Referring to FIG. 10, a series filter 212 includes two or membranes 116a and 116b stacked in series to receive a fluid 204 with particles 206, contaminants 208, etc. therein. The particles 206, etc. are trapped by the membrane 116a if they are larger than the inner diameters of the CNTs 104 of a first membrane 116a. Smaller particles can pass through with filtered fluid 208 to a second membrane 116b, which can be configured with same sized CNTs 104 or different sized CNTs 104 (e.g., to further refine the filtering). The second membrane 116b provides multiple filtered fluid 210.

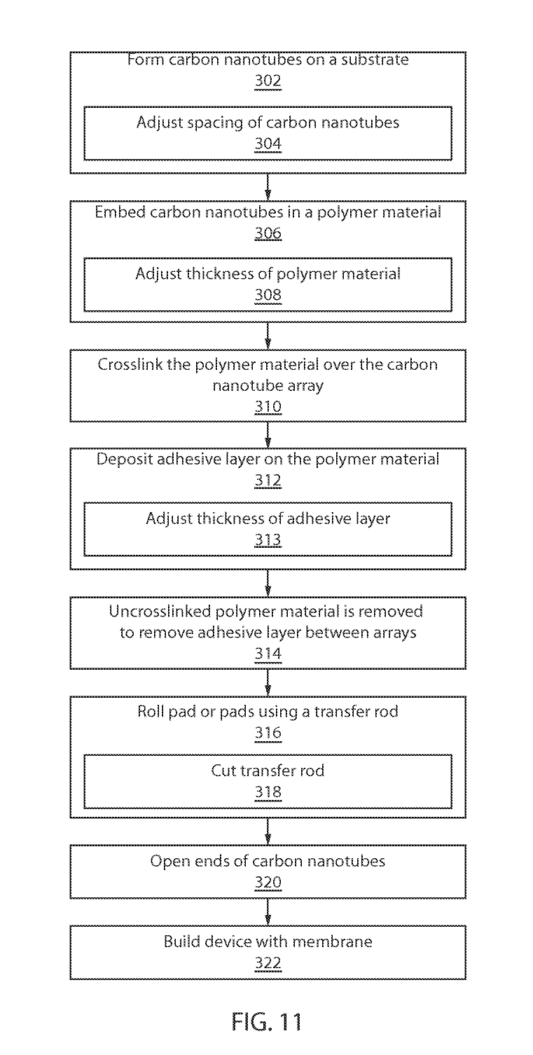

Referring to FIG. 11, methods for forming a nanopore membrane are illustratively shown. It should be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagram and/or flowchart illustration, and combinations of blocks in the block diagram and/or flowchart illustration, can be implemented by special purpose hardware-based systems that perform the specified functions or acts, or combinations of special purpose hardware and computer instructions.

In block 302, at least one array of carbon nanotubes is formed on a substrate such that the carbon nanotubes are disposed side by side in a direction perpendicular to a length of the carbon nanotubes. In block 304, spacings between the carbon nanotubes may be adjusted to adjust pore density in a membrane to be formed.

In block 306, the array or arrays of carbon nanotubes are embedded in a patternable polymer material. The polymer material is deposited over the carbon nanotubes. In block 308, a thickness of the polymer material can be adjusted to adjust pore density in the membrane.

In block 310, the patternable polymer material is crosslinked over the array(s) of carbon nanotubes. This leaves uncrosslinked polymer material between crosslinked portions. In block 312, an adhesive layer is deposited on the polymer material (on both crosslinked and uncrosslinked portions). In block 313, a thickness of the adhesive layer can be adjusted to adjust the pore density of the final membrane. In block 314, uncrosslinked polymer material is removed between the crosslinked carbon nanotube arrays to remove the adhesive layer between the arrays such that multiple carbon nanotube arrays are formed as pads (pads includes carbon nanotubes, crosslinked polymer material and adhesive layer).

In block 316, the pad or pads are rolled using a transfer rod to form a membrane with carbon nanotubes of the array forming nanopores through the membrane such that as the pad is rolled the membrane increases in diameter. The thickness of the cross-linkable material will determine not only the pore distribution and density in the resulting membrane, but also the size of the membrane. In block 318, the transfer rod is cut to form an individual membrane.

In block 320, the membrane may be etched (e.g., plasma etching) or otherwise processed to ensure the nanopores (carbon nanotubes) are open. In block 322, one or more membranes may be employed to build a filter, sensor or any other useful device.

Having described preferred embodiments for carbon nanotube based nanoporous membranes (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims.

Having thus described aspects of the invention, with the details and particularity required by the patent laws, what is claimed and desired protected by Letters Patent is set forth in the appended claims:

1. A method for forming a nanopore membrane, comprising:
forming on a substrate at least one array of carbon nanotubes such that the carbon nanotubes are disposed side by side in a direction perpendicular to a length of the carbon nanotubes;
embedding the at least one array of carbon nanotubes in a patternable polymer material;
crosslinking the patternable polymer material over the at least one array of carbon nanotubes;
depositing an adhesive layer on the polymer material with the at least one array of carbon nanotubes to form a pad; and
rolling the pad using a transfer rod to form a membrane with carbon nanotubes of the at least one array forming nanopores through the membrane such that as the pad is rolled the membrane increases in diameter.

2. The method as recited in claim 1, further comprising: removing uncrosslinked polymer material between carbon nanotube arrays to remove the adhesive layer thereon between the arrays such that multiple carbon nanotube arrays are rolled concurrently.

3. The method as recited in claim 1, further comprising: cutting the transfer rod to form the membrane.

4. The method as recited in claim 1, further comprising: adjusting spacings between the carbon nanotubes to adjust pore density in the membrane.

5. The method as recited in claim 1, further comprising: adjusting a thickness of the pad to adjust at least one of pore density in the membrane and a size of the membrane.

6. The method as recited in claim 1, further comprising: plasma etching the membrane to ensure the nanopores are opened.

7. The method as recited in claim 1, further comprising: building a filter using one or more membranes.

8. A method for forming a nanopore membrane, comprising:
forming on a substrate a plurality carbon nanotube arrays such that the carbon nanotubes in each array are disposed side by side in a direction perpendicular to a length of the carbon nanotubes, the arrays being adjacent to one another in a direction of the length of the carbon nanotubes;
embedding the arrays of carbon nanotubes in a patternable polymer material;
crosslinking the patternable polymer material over the arrays of carbon nanotubes;
depositing an adhesive layer on the polymer material;
removing uncrosslinked polymer material between the arrays of carbon nanotubes to remove the adhesive layer thereon between the arrays such that pads are formed, the pads including polymer material with embedded carbon nanotubes and the adhesive layer; and
rolling the pad using a transfer rod to form a membrane with carbon nanotubes of the arrays forming nanopores through the membrane such that as the pad is rolled the membrane increases in diameter.

9. The method as recited in claim 8, wherein rolling the pad using a transfer rod includes concurrently rolling a plurality of pads with a same transfer rod.

10. The method as recited in claim 8, further comprising: cutting the transfer rod to form the membrane.

11. The method as recited in claim 8, further comprising: adjusting spacings between the carbon nanotubes to adjust pore density in the membrane.

12. The method as recited in claim 8, further comprising: adjusting a thickness of the pad to adjust pore density in the membrane.

13. The method as recited in claim 8, further comprising: plasma etching the membrane to ensure the nanopores are opened.

14. The method as recited in claim 8, further comprising: building a filter using one or more membranes.

15.-19. (canceled)
